(19) United States
(12) Patent Application Publication
(10) Pub. No.: US 2020/0011086 A1
(43) Pub. Date: Jan. 9, 2020

(54) SUITCASE COMBINATION LOCK

(71) Applicant: YIFENG MANUFACTURING CO.,LTD., DONGGUAN City (CN)

(72) Inventors: Leo LAI, DONGGUAN City (CN); Jinghui GUO, DONGGUAN City (CN)

(21) Appl. No.: 16/490,025

(22) PCT Filed: Dec. 12, 2017
(86) PCT No.: PCT/CN2017/115524

§ 371 Date: Aug. 29, 2019

(30) Foreign Application Priority Data
Mar. 13, 2017 (CN) 201710147302.5

(51) Int. Cl. E05B 37/02; E05B 65/52

(52) U.S. Cl. CPC E05B 37/02; E05B 65/52

(57) ABSTRACT

A suitcase combination lock includes a locking element and a password element for controlling the movement of the locking element. Both ends of the password element have the locking element, and a swingable adapter installed between the two locking elements, and the two locking elements are connected to both ends of the adapter respectively, so that the two locking elements can jointly drive the adapter to swing, and the two locking assemblies are linked with each other. The two locking assemblies can move outwardly or inwardly at the same time. If the password is correct, and a position of the suitcase with one of the locking elements is hit, a single locking element cannot be moved easily to prevent a lock hook of the locking element from being rotated, and prevent a lock failure of the locking assembly.

### FIELD OF INVENTION

The present disclosure relates to the field of combination locks, in particular to a suitcase combination lock.

### BACKGROUND OF INVENTION

### Description of the Related Art

In general, a suitcase combination lock has an opening/closing gap, two opening/closing sides disposed on both sides of the opening/closing gap respectively, and a combination lock installed into an inner wall of one of the opening/closing sides, wherein the combination lock has a combination lock wheel and a locking assembly installed at both ends of the combination lock separately. The locking assembly comprises: a connecting part, a lock block, and a lock hook. If the password of the combination lock wheel is correct, the combination lock wheel will not hinder the movement of the connecting part, and the connecting part moving in a direction towards the combination lock will drive the lock block to rotate to a position that does not hinder the lock hook, so that the lock hook can be rotated freely to achieve an unlocking effect. In the prior art, the two locking elements disposed at both ends of the combination lock wheel are not linked with each other, so that if the password is correct and the suitcase is hit, the connecting part of one of the locking elements will be moved easily, and the lock hook of the locking element will be rotated to cause a lock failure of the locking assembly.

### SUMMARY OF THE INVENTION

Therefore, it is a primary objective of the present disclosure to overcome the aforementioned drawback of the prior art by providing a suitcase combination lock capable of preventing a lock failure of the locking assembly when the suitcase is hit.

To achieve the aforementioned and other objectives, the present disclosure provides a suitcase combination lock comprising a locking element and a password element for controlling the movement of the locking element, characterized in that the locking element is installed at both ends of the password element separately, and a swingable adapter is installed between the two locking elements, and the two locking elements are coupled to both ends of the adapter respectively, so that the two locking elements can jointly drive the adapter to swing, so as to link the two locking assemblies with each other.

Specifically, each locking assembly comprises a moving part capable of moving reciprocally, a lock hook for engaging a lock buckle and capable of rotating, and a rotary lock block installed between the moving part and the lock hook, and an inner end of the moving part is coupled to the adapter, so that the moving part can drive the adapter to swing, and the moving part is capable of driving the rotary lock block to a position that does not hinder the lock hook, so as to achieve the effect of unlocking the suitcase combination lock

Specifically, the adapter has a cylindrical portion, two outer sidewalls disposed on the cylindrical portion, and a transmission arm extending outwardly along the radial direction of the cylindrical portion.

Specifically, one of the moving parts has a transmission hole formed thereon and provided for passing an end of the corresponding transmission arm, and the moving part is capable of passing through the transmission hole to drive the adapter to swing in a moving process.

Specifically, the other one of the moving parts has a transmission notch formed thereon and configured to be corresponsive to an end of the transmission arm, and the moving part is capable of passing through the transmission notch to drive the adapter to swing in a moving process.

Specifically, both transmission arms include a transmission part having a circular arc surface on a side and disposed at an end of each transmission arm, and the transmission part is built in the corresponding transmission hole or transmission notch.

Specifically, the two transmission arms are disposed on two opposite sides of the cylindrical portion respectively, and an inner end of the moving part has a bent plate, and the transmission notch is formed at an inner end portion of the bent plate.

Specifically, the cylindrical portion has an anti-detachment retainer configured to be corresponsive to a side of the bent plate and provided for preventing the transmission arm and the transmission notch from separating from each other.

This disclosure has the following advantageous effect:

The adapter is rotatably installed between the two locking elements and the two moving parts are hinged to the adapter, so that the two locking assemblies are linked with each other. In other words, the two locking assemblies can move outwardly or inwardly at the same time. When the password is correct and the casing of the suitcase having one of the locking elements is hit, a single locking element will not be moved easily because the two locking assemblies are linked with each other, so as to prevent one of the lock hooks of the locking element from rotating, and present a lock failure of the locking assembly.

### BRIEF DESCRIPTION OF THE DRAWINGS

FIG. 1 is a schematic view of a suitcase combination lock installed to a suitcase in accordance with the present disclosure;

FIG. 2 is another schematic view of a suitcase combination lock installed to a suitcase in accordance with the present disclosure;

FIG. 3 is a schematic view showing a part of the interior of a suitcase combination lock in accordance with the present disclosure;

FIG. 4 shows another view of FIG. 3;

FIG. 5 is a schematic view showing another part of the interior of a suitcase combination lock in accordance with the present disclosure when the suitcase combination lock is situated at a locked state;

FIG. 6 is a schematic view showing the structure of a suitcase combination lock as depicted in FIG. 5 when the suitcase combination lock is situated at a locked state;

FIG. 7 is a blowup view of Section A of FIG. 5; and

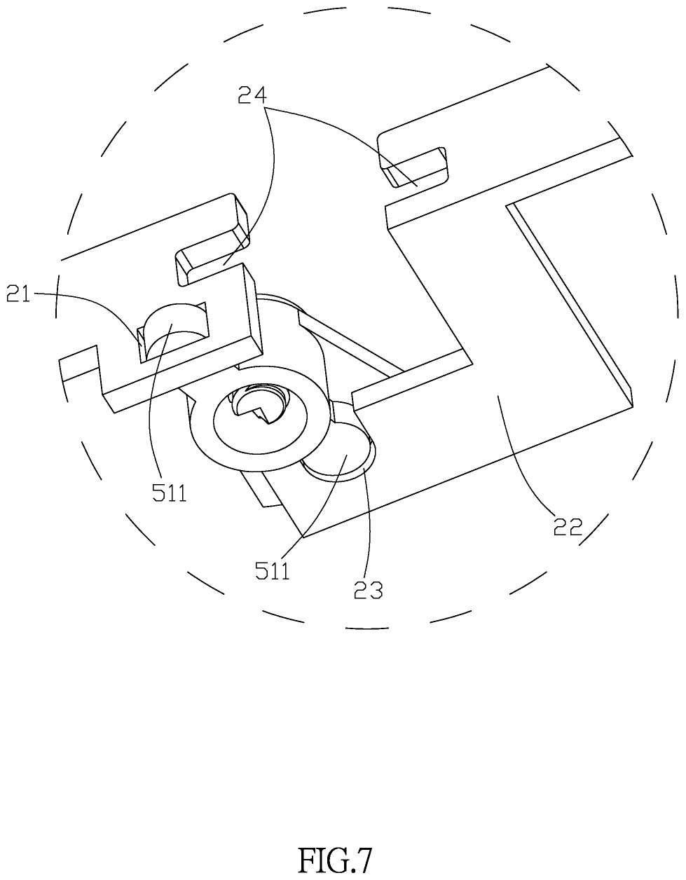

FIG. 8 is a perspective view of an adapter in accordance with the present disclosure.

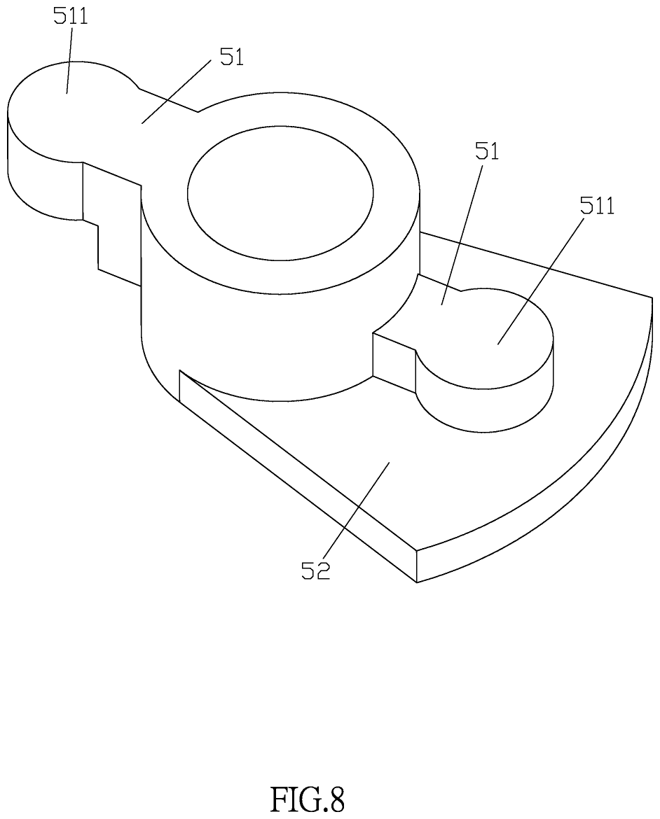

### BRIEF DESCRIPTION OF NUMERALS USED IN THE FIGURES

11: Casing; 12: Lock buckle; 2: Moving part; 21: Transmission hole; 22: Bent plate; 23: Transmission notch; 24: Accommodation notch; 3: Lock hook; Rotary lock block; 5: Adapter; 51: Transmission arm; 511: Transmission part; 52: Anti-detachment retainer; 6: Pressing plate; 61: Abutting portion.

### DESCRIPTION OF THE PREFERRED EMBODIMENTS

The present disclosure will become clearer in light of the following detailed description of an illustrative embodiment of this disclosure described in connection with the drawings, so that people having ordinary skill in the art can implement the present disclosure according to the description of this specification.

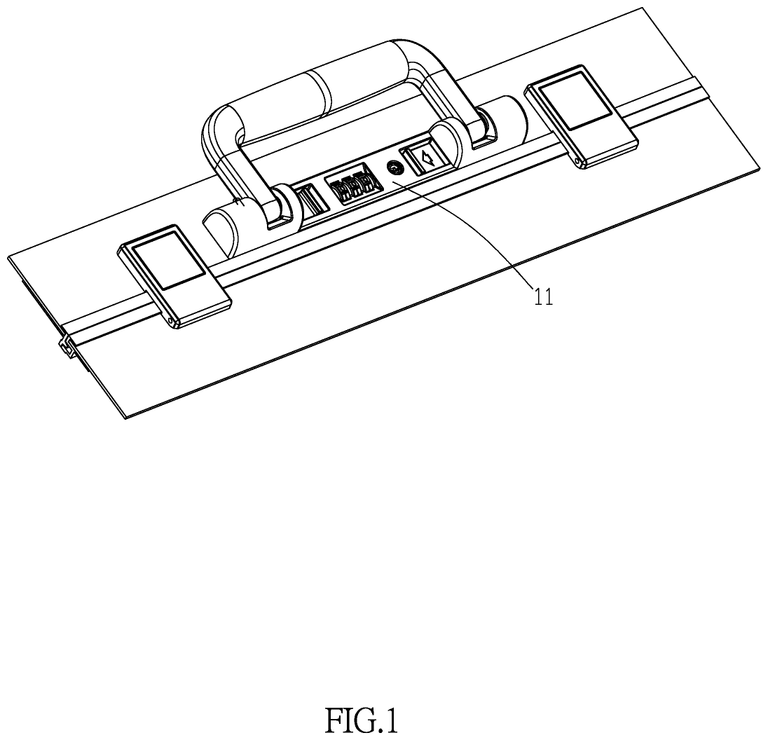

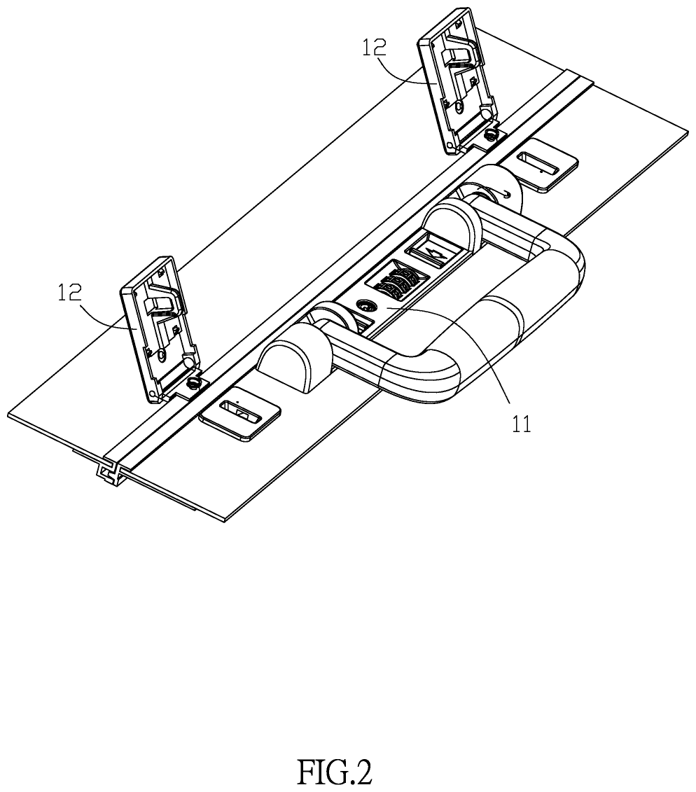

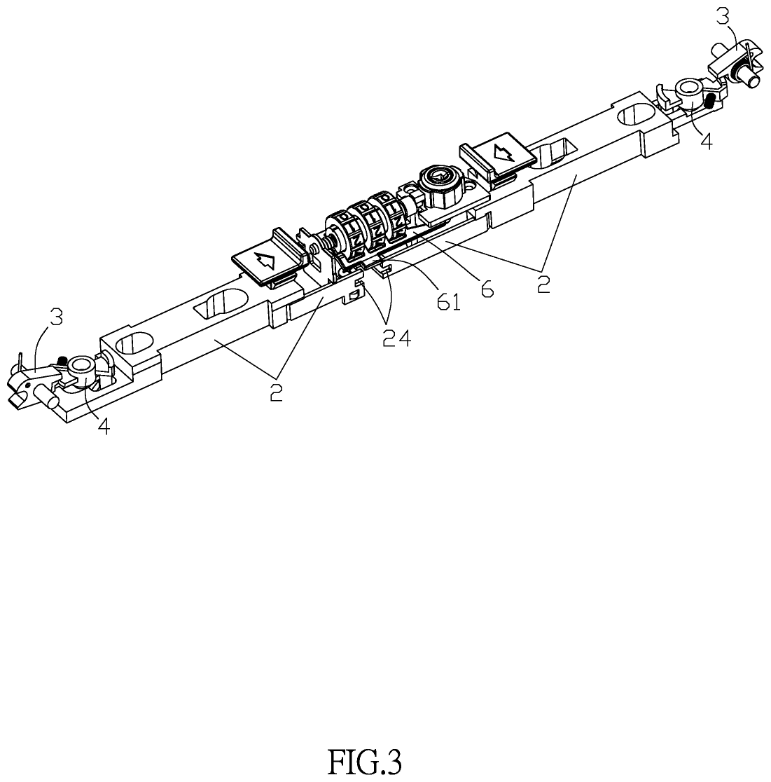

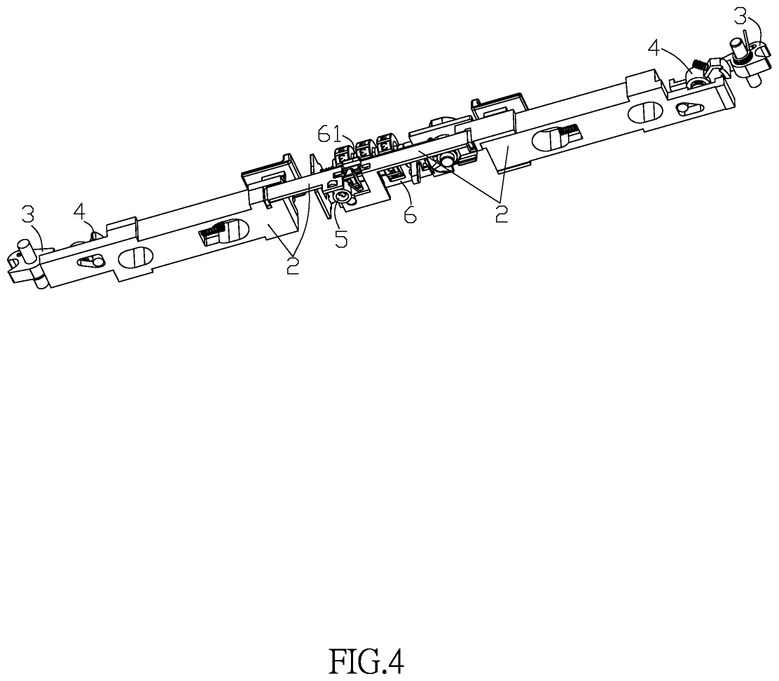

With reference to FIGS. 1 and 2 for a suitcase combination lock in accordance with a preferred embodiment of this disclosure, the suitcase combination lock comprises a casing 11 installed on one of the opening/closing sides of a suitcase, a password element installed in the casing 11, a lock core and locking elements installed at both ends of the password element respectively. In FIGS. 3 and 4, each locking assembly comprises a moving part 2 capable of moving reciprocally along the lengthwise direction of the casing 11, a lock hook 3 disposed on the other opening/closing side of the suitcase and hinged to the casing 11 for hooking the look buckle 12 (as shown in FIG. 2), and a rotary lock block 4 in disposed between the moving part 2 and the lock hook 3. The password element comprises a pressing plate 6 having an abutting portion 61 for abutting the two moving parts 2. Both moving parts 2 have an accommodation notch 24 formed at an inner end thereof and provided for accommodating the abutting portion 61. If the password is incorrect and the key has not unlocked the suitcase, both ends of the abutting portion 61 will abut against the inner ends (not shown in this figure) of the two moving parts 2 respectively, so that the two moving parts 2 cannot move towards the inner side. If the password is correct (without using the key yet), the pressing plate 6 will swing to a position misaligned with the inner ends of the two moving parts 2 (as shown in FIGS. 2 and 3), so that the two moving parts 2 can move towards the inner side; and if a key is used for unlocking the suitcase (when the password is incorrect), the key drives the lock core to rotate, so as to drive the pressing plate 6 to swing to the abutting portion 61 and enter into the accommodation notch 24 (not shown in this figure). Therefore, the two moving parts 2 can move towards the inner side.

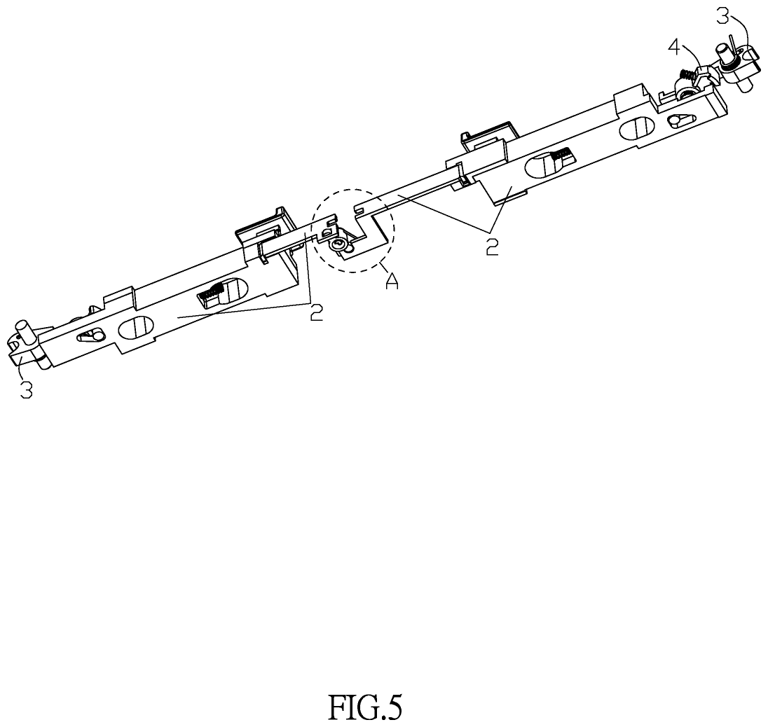

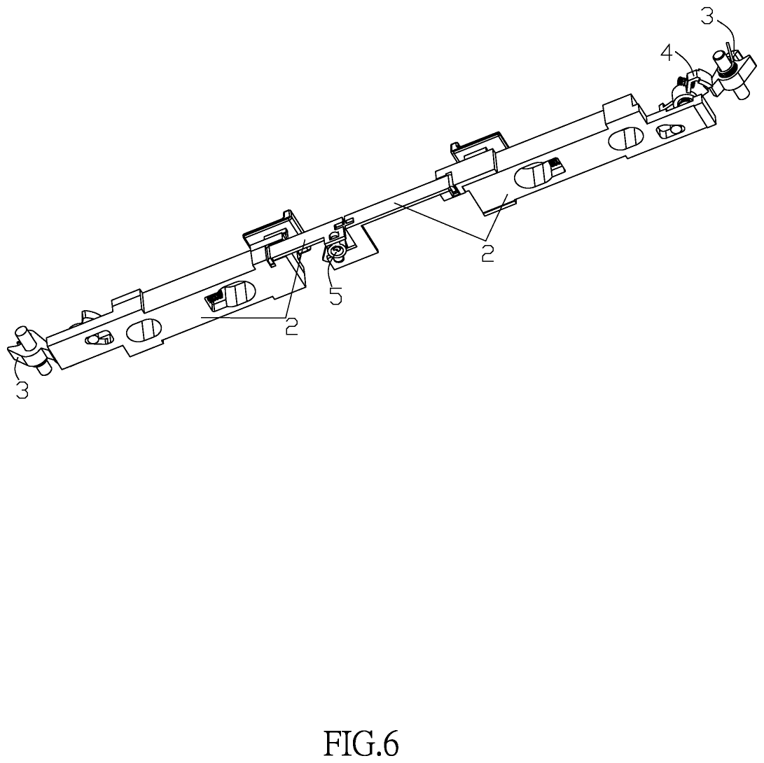

In the process of moving the moving part 2 towards the inside as shown in FIGS. 5 and 6, the moving part 2 drives the rotary lock block 4 to rotate to a position that does not hinder the lock hook 3. In other words, the lock hook 3 can be rotated to a position that does not hook the lock buckle 12, so as to unlock the suitcase combination lock (as shown in FIG. 2, wherein the lock buckle 12 on the left side of FIG. 2 is hooked by the lock hook 3 and situated in an unlocked state). The inner end of each of the two moving parts 2 is hinged with the adapter 5 of the casing 11, and the adapter 5 has a cylindrical portion hinged with the casing 11 and two transmission arms 51 disposed on the outer sidewall of the cylindrical portion and extending in a radial direction along the cylindrical portion. The two transmission arms 51 have a transmission part 511 disposed at an end of the transmission arm and having a side which is a circular arc surface. The inner side of each of the two moving parts 2 is coupled to the adapter 5, so that the two locking elements can jointly drive the adapter 5 to drive, so as to link the two locking assemblies with each other. The moving part 1 of one of the locking elements has a transmission hole 21, and the transmission part 511 is passed through the transmission hole 21, and a gap between a side of the transmission part 511 and the transmission hole 21 is reserved for the transmission process. In the moving process, the moving part 2 can pass through the transmission hole to drive the adapter to swing.

The two transmission arms 51 are disposed on two opposite sides of the cylindrical portion respectively, wherein the tail of the moving part 2 of the other locking element has a bent plate 22, and the bent plate 22 and the other moving part 2 are fitted to one transmission arm 51. A transmission notch 23 is formed at an inner end portion of the bent plate 22 and configured to be corresponsive to the transmission part 511. In the moving process, the moving part 2 can pass through the transmission notch 23 to drive the adapter 5 to swing. The cylindrical portion has an anti-detachment retainer 52 configured to be corresponsive to a side of the bent plate 22 for preventing the transmission part 511 and the transmission notch 23 from separating from each other. Specifically, the anti-detachment retainer 52 and the bottom of an inner cavity of the casing 11 jointly limit the transmission arm 51 to prevent the transmission part 511 and the transmission notch 23 from separating from each other.

While the present disclosure has been described by means of specific embodiments, numerous modifications and variations could be made thereto by those skilled in the art without departing from the scope and spirit of this disclosure set forth in the claims.

What is claimed is:

1. A suitcase combination lock, comprising a locking element and a password element for controlling the movement of the locking element, characterized in that the locking element is installed at both ends of the password element separately, and a swingable adapter (5) is installed between the two locking elements, and the two locking assemblies are coupled to both ends of the adapter (5) respectively, so that the two locking elements can jointly drive the adapter (5) to swing in order to link the two locking assemblies with each other.

2. The suitcase combination lock of claim 1, wherein each locking assembly comprises a moving part (2) capable of moving reciprocally, a lock hook (3) for engaging a lock buckle (12) and capable of rotating, and a rotary lock block (4) installed between the moving part (2) and the lock hook (3), and an inner end of the moving part (2) is coupled to the adapter (5), so that the moving part (2) can drive the adapter (5) to swing, and the moving part (2) is capable of driving the rotary lock block (4) to a position that does not hinder the lock hook (3), so as to unlock the suitcase combination lock.

3. The suitcase combination lock of claim 2, wherein the adapter (5) has a cylindrical portion, two outer sidewalls disposed on the cylindrical portion, and a transmission arm (51) extending outwardly along the radial direction of the cylindrical portion.

4. The suitcase combination lock of claim 3, wherein one of the moving parts (2) has a transmission hole (21) formed thereon and provided for passing an end of the corresponding transmission arm (51), and the moving part (2) is capable of passing through the transmission hole (21) to drive the adapter (5) to swing in a moving process.

5. The suitcase combination lock of claim 4, wherein the other one of the moving parts (2) has a transmission notch (23) formed thereon and configured to be corresponsive to an end of the transmission arm (51), and the moving part (2) is capable of passing through the transmission notch (23) to drive the adapter (5) to swing in a moving process.

6. The suitcase combination lock of claim 5, wherein both transmission arms (51) have a transmission part (511) having a circular arc surface on a side and disposed at an end of each transmission arm (51), and the transmission part (511) is built in the corresponding transmission hole (21) or transmission notch (23).

7. The suitcase combination lock of claim 5, wherein the two transmission arms (51) are disposed on two opposite sides of the cylindrical portion respectively, and an inner end of the moving part (2) has a bent plate (22), and the transmission notch (23) is formed at an inner end portion of the bent plate (22).

8. The suitcase combination lock of claim 7, wherein the cylindrical portion has an anti-detachment retainer (52) configured to be corresponsive to a side of the bent plate (22) and provided for preventing the transmission arm (51) and the transmission notch (23) from separating from each other.
